(19) United States
(12) Patent Application Publication
(10) Pub. No.: US 2023/0189150 A1
(43) Pub. Date: Jun. 15, 2023

(54) POWER SAVING ENHANCEMENTS WITH TRACKING REFERENCE SIGNAL (TRS) IN IDLE MODE

(71) Applicant: Media Tek INC., Hsin-Chu (TW)

(72) Inventors: Chi-Hsuan Hsieh, Hsin-Chu (TW); Yi-ju Liao, Hsin-Chu (TW); Wei-De Wu, Hsin-Chu (TW)

(21) Appl. No.: 18/105,769

(22) Filed: Feb. 3, 2023

Related U.S. Application Data
(63) Continuation of application No. PCT/CN2021/110802, filed on Aug. 5, 2021.
(60) Provisional application No. 63/061,208, filed on Aug. 5, 2020.

(51) Int. Cl. H04W 52/02

(52) U.S. Cl. CPC H04W 52/0229; H04W 52/0216

(57) ABSTRACT

A method of providing tracking reference signal (TRS) in idle mode for power consumption enhancements is proposed. A user equipment (UE) operates in an idle mode of communication with a wireless communication network, and receives a system information block (SIB) or a paging early indication (PEI) from the wireless communication network when the UE is in the idle mode. The received SIB or PEI includes TRS configuration. The UE detects a TRS from the wireless communication network based on the TRS configuration when the UE is in the idle mode.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/CN2021/110802, with an international filing date of Aug. 5, 2021, which in turn claims priority from U.S. Provisional Application No. 63/061,208, entitled “R17 Idle mode power saving Potential TRS,” filed on Aug. 5, 2020. This application is a continuation of International Application No. PCT/CN2021/110802, which claims priority from U.S. provisional applications 63/061,208. International Application No. PCT/CN2021/110802 is pending as of the filing date of this application, and the United States is a designated state in International Application No. PCT/CN2021/110802. The disclosure of each of the foregoing documents is incorporated herein by reference.

### TECHNICAL FIELD

The disclosed embodiments relate generally to wireless communication systems, and, more particularly, to power saving enhancements with tracking reference signal (TRS) in idle mode.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards. The next generation mobile network (NMN) board, has decided to focus the future NGMN activities on defining the end-to-end requirements for 5G new radio (NR) systems.

In 5G NR, various types of reference signals, including demodulation reference signals (DMRS), phase-tracking reference signals (PT-RS), sounding reference signals (SRS), channel state information reference signals (CSI-RS), and tracking reference signals (IRS), are introduced, and each type of reference signals serves a specific purpose. For example, IRS are sparse reference signals intended to assist connected-mode UE in time and frequency tracking, and the IRS configuration is carried in specific information element (IF) available only through radio resource control (PRO) signaling in connected mode. On the other hand, an idle-mode UE may need to receive several synchronization signal blocks (SSBs) to acquire sufficient information for time and frequency, racking before each Paging Occasion (PO) and SSB-based measurement timing configuration (INTO) window. Since SSBs are periodic signals, idle-mode UE needs to wake up from sleep mode for several times to receive SSBs. Even though idle-mode UE's power consumption can be saved by entering sleep, mode in the times where no SIB is transmitted, the constant waking up for SIB reception is still inefficient in power saving.

A solution is sought.

### SUMMARY

A method of providing tracking reference signal (TRS) in idle mode for power consumption enhancements is proposed. A user equipment (UE) operates in an idle mode of communication with a wireless communication network, and receives a system information block (SIB) or a paging early indication (PEI) from the wireless communication network when the UE is in the idle mode. The received SIB or PEI comprises TRS configuration. The UE detects a TRS from the wireless communication network based on the TRS configuration when the UE is in the idle mode.

On the other hand, the wireless communication network transmits a SIB or a PEI to the UE when the UE is operating in an idle mode of communication with the wireless communication network. The transmitted SIB or PEI comprises TRS configuration. The wireless communication network transmits a TRS to the UE in the idle mode based on the TRS configuration.

In one embodiment, the UE performs time and/or frequency tracking in the idle mode based on the detected TRS, and based on the performed time and/or frequency tracking, enters a sleep mode for a period of time spanning one or more occasions configured for Synchronization Signal Block (SSB) reception. In one example, the entering of the sleep mode is performed by skipping the one or more occasions configured for SSB reception.

In one embodiment, the SIB is in an existing type of SIB in a third generation partnership project (3GPP) specification for 5G new radio (NR), or in a new type of SIB additionally introduced to the 3GPP specification for 5G NR. In one example, the existing type of SIB is a type-2 SIB. In another example, the new type of SIB is a type-15 SIB.

In one embodiment, the TRS configuration comprises one or more periodic non-zero-power (NZP) channel state information-reference signal (CSI-RS) resource sets and TRS information (i.e., trs-info) of that the NZP CSI-RS resource sets are configured for TRS. In one example, each of the NZP CSI-RS resource sets comprises at least one of the following: (1)an information element (IE) indicating a frequency domain resource allocation; (2) an IE indicating a time domain allocation of a first orthogonal frequency-division multiplexing (OFDM) symbol in a physical resource block (PRB) used for CSI-RS; (3) an IE indicating a number of consecutive slots containing the TRS; (4) an IE indicating a PRB where this CSI resource starts in relation to common resource block #0 (CRB#0) on the common resource block grid; (5) an IE indicating a number of PRBs across which this CSI resource spans; (6) an IE indicating a power offset of Physical Downlink Shared Channel (PDSCH) Resource Element (RE) to NZP CSI-RS RE; (7) an IE indicating a power offset of NZP CSI-RS RE to secondary synchronization signal (SSS) RE; (8) one or more IEs indicating one or more scrambling IDs; and (9) an IE indicating a periodicity and a corresponding slot offset. In one example, the scrambling IDs are configured with consecutive numbers, or only the first or last scrambling ID is configured with a number.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio (NR) network 100 supporting idle-mode tracking reference signal (TRS) in accordance with aspects of the current invention.

FIG. 2 is a simplified block diagram of wireless devices 201 and 211 in accordance with embodiments of the present invention.

FIG. 3 illustrates the concept of providing TRS in idle mode for additional power saving in accordance with one novel aspect of the present invention.

FIG. 4 illustrates the generation of TRS for idle-mode UE in accordance with one novel aspect of the present invention.

FIG. 5 illustrates an exemplary structure of the TRS configuration in accordance with one novel aspect of the present invention.

FIG. 6 is a flow chart of a method of providing TRS in idle mode for power consumption enhancements from UE perspective in accordance with one novel aspect of the present invention.

FIG. 7 is a flow chart of a method of providing TRS in idle mode for power consumption enhancements from network perspective in accordance with one novel aspect of the present invention.

### DETAILED DESCRIPTION

Reference will now be made in detail to some embodiments of the invention, examples of which are illustrated in the accompanying drawings.

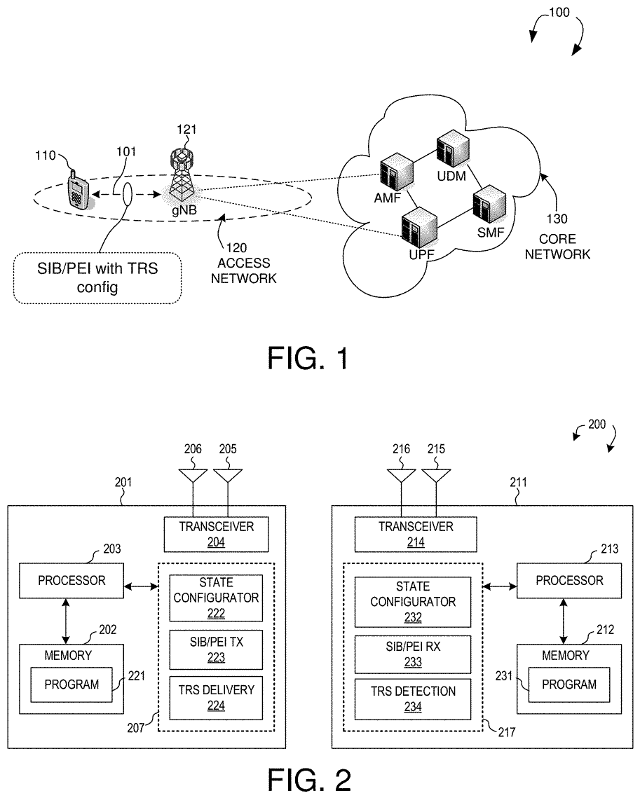

FIG. 1 illustrates an exemplary 5G new radio (NR) network 100 supporting idle-mode tracking reference signal (TRS) in accordance with aspects of the current invention. The 5G NR network 100 comprises a user equipment (UE) 110 communicatively connected to a gNB 121 operating in a licensed band (e.g., 30 GHz˜300 GHz for mmWave) of an access network 120 which provides radio access using a radio access technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of things (IoT) device, and a tablet, etc. Alternatively, UE 110 may be a notebook (NB) or personal computer (PC) inserted or installed with a data card which includes a modem and radio frequency (RF) transceiver(s) to provide the functionality of wireless communication.

The gNB 121 may provide communication coverage for a geographic coverage area in which communications with the UE 110 is supported via a communication link 101. The communication link 101 between the gNB 121 and the UE 110 may utilize one or more frequency carriers to form one or more cells (e.g., a PCell and one or more SCells). The communication link 101 shown in the 5G NR network 100 may include uplink transmissions from the UE 110 to the gNB 121 (e.g., on the Physical Uplink Control Channel (PUCCH) or Physical Uplink Shared Channel (PUSCH)) and/or downlink transmissions from the gNB 121 to the UE 110 (e.g., on the Physical Downlink Control Channel (PDCCH) or Physical Downlink Shared Channel (PDSCH)).

In accordance with one novel aspect, the downlink transmissions over the communication link 101 may carry a system information block (SIB) (e.g., an existing SIB, such as type-2 SIB, or a new SIB, such as type-15 SIB) or a paging early indication (PEI) (e.g., a PDCCH-based PEI or an SSS/TRS-sequence-based PEI) which includes TRS configuration, when the UE 110 is operating in an idle mode (e.g., RRC_IDLE mode). The idle-mode UE 110 may then detect TRS from the wireless communication network based on the TRS configuration, and performs time and/or frequency tracking in the idle mode based on the detected TRS. Based on the performed time and/or frequency tracking, the idle-mode UE 110 may enter a sleep mode for a period of time spanning one or more occasions configured for Synchronization Signal Block (SSB) reception, to reduce power consumption.

FIG. 2 is a simplified block diagram of wireless devices 201 and 211 in accordance with embodiments of the present invention. For wireless device 201 (e.g., a base station), antennae 205 and 206 transmit and receive radio signal. RF transceiver module 204, coupled with the antennae 205 and 206, receives RF signals from the antennae 205 and 206, converts them to baseband signals and sends them to processor 203. RF transceiver 204 also converts received baseband signals from the processor 203, converts them to RF signals, and sends out to antennae 205 and 206. Processor 203 processes the received baseband signals and invokes different functional modules and circuits 207 to perform features in wireless device 201. Memory 202 stores program instructions and data 221 to control the operations of wireless device 201.

Similarly, for wireless device 211 (e.g., a UE), antennae 215 and 216 transmit and receive RF signals. RF transceiver module 214, coupled with the antennae 215 and 216, receives RF signals from the antennae 215 and 216, converts them to baseband signals and sends them to processor 213. The RF transceiver 214 also converts received baseband signals from the processor 213, converts them to RF signals, and sends out to antennae 215 and 216. Processor 213 processes the received baseband signals and invokes different functional modules and circuits 217 to perform features in wireless device 211. Memory 212 stores program instructions and data 231 to control the operations of the wireless device 211.

In the wireless devices 201 and 211, the functional modules and circuits 207 and 217 can be implemented and configured to perform embodiments of the present invention. In the example of FIG. 2, the wireless device 201 is a base station (e.g., gNB) that includes a state configurator circuit 222 that configures the wireless device 211 to operate in an idle mode of communication with the wireless device 201, a SIB/PEI transmitter (Tx) circuit 223 that transmits a SIB/PEI comprising TRS configuration to the wireless device 211, and a TRS delivery circuit 224 that transmits the TRS configuration to the wireless device 211. The wireless device 211 is a UE that includes a state configurator circuit 232 that configures the wireless device 211 to operate in an idle mode of communication with the wireless device 201, a SIB/PEI receiver (Rx) circuit 233 that receives a SIB/PEI comprising TRS configuration from the wireless device 201 when the wireless device 211 is in the idle mode, and a TRS detection circuit 234 that detects a TRS from the wireless device 201 based on the TRS configuration when the wireless device 211 is in the idle mode. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 221 and 231), allow base station 201 and UE 211 to perform embodiments of the present invention.

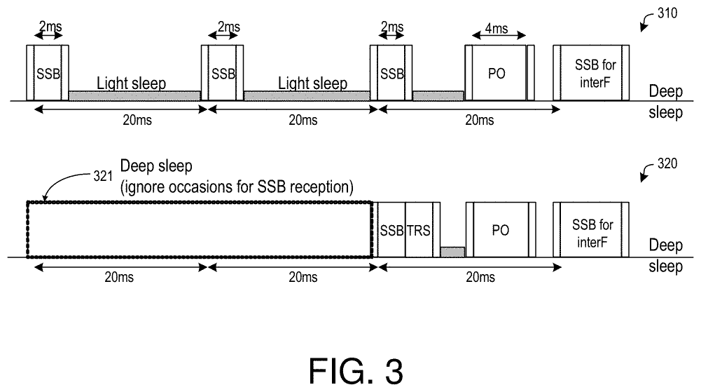

FIG. 3 illustrates the concept of providing TRS in idle mode for additional power saving in accordance with one novel aspect of the present invention. Diagram 310 of FIG. 3 depicts the SSB transmission scheme in NR, where LOOP operations (including AGC, FTL, and TTL) and measurements (MEAS) can only be performed in certain occasions, e.g., during SSB bursts. UE wakes up for SSBs, e.g., every 20 ms (every 2 radio frames). UE may enter light sleep mode (e.g., a first power saving mode with higher power consumption) in the gap between the SSBs for LOOP/MEAS and paging occasion (PO). When TRS for idle-mode UE is introduced, UE can skip one or more occasions configured for SSB reception, e.g., entering a deep sleep mode (e.g., a second power saving mode with lower power consumption) in 321. Note that Low-SINR UEs need to wake up earlier, i.e., monitor more SSB bursts (larger N_{SSB}) before being able to decode paging message. High-SINR UEs may wake up later before PO monitoring.

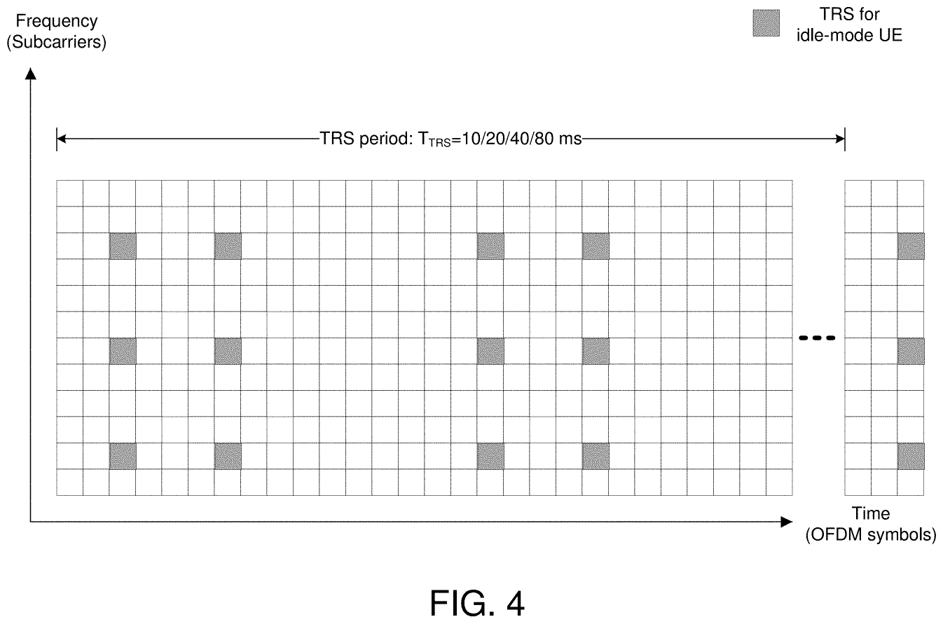

To be more specific, TRS is an periodic non-zero-power (NZP)-CSI-RS-ResourceSet configured with trs-Info and composed of 2 or 4 nzp-CSI-RS-Resource. Each nzp-CSI-RS-Resource resource is 1-port and of density 3. A UE (e.g., an idle-mode UE) can be configured with one or more NZP CSI-RS set(s) with trs-info. There should be no CSI-ReportConfig for TRS (no need to report CSI for TRS). Periodic TRS can be configured with a periodicity of 10, 20, 40, or 80 ms. The bandwidth (BW) of TRS is the minimum of 52 and N_{BWP,i}^{size}, resource blocks, or is equal to N_{BWP,i}^{size}, resource blocks. FIG. 4 illustrates the generation of TRS for idle-mode UE in accordance with one novel aspect of the present invention. The exemplary TRS structure is shown to be configured with four single-port, Density-3 CSI-RS over two consecutive slots. The two CSI-RS within a slot are always separated by four symbols in the time domain. In the example of FIG. 4, the periodic NZP CSI-RS is 2 resources per slot. For 5G NR in Frequency Range 1 (FR1), the periodic NZP CSI-RS is 4 resources in 2 consecutive slots. For 5G NR in FR2, the periodic NZP CSI-RS is 4 resources in 2 consecutive slots or 2 resources in a slot.

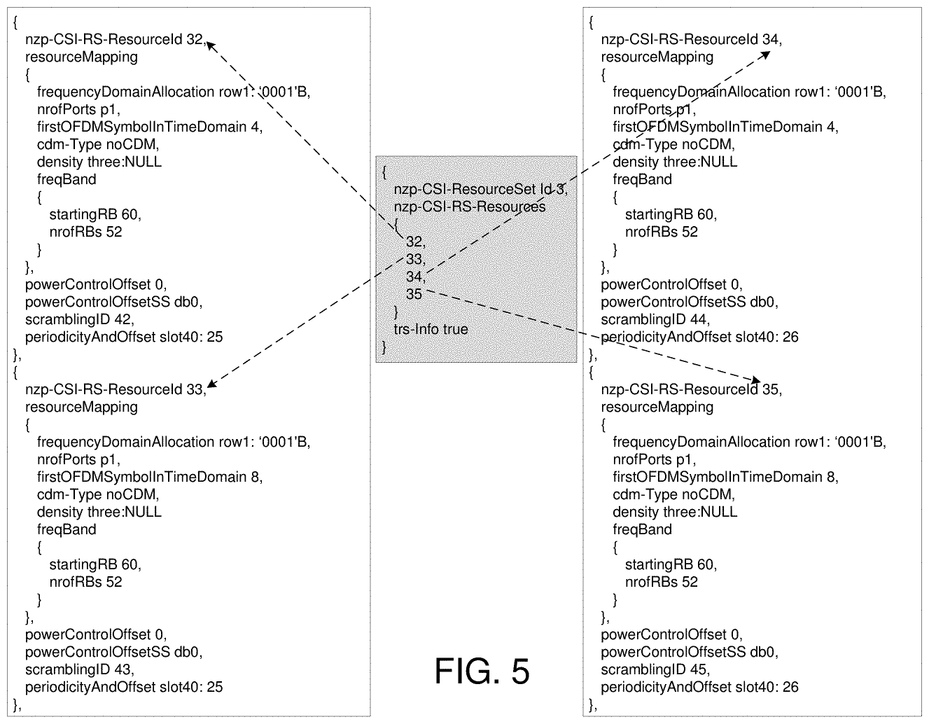

Therefore, a TRS configuration includes information on one or more periodic NZP CSI-RS resource sets and TRS information (i.e., trs-Info) of that the NZP CSI-RS resource sets are configured for TRS. Specifically, the information on each of the NZP CSI-RS resource sets may include any combination of the following:
(1)“frequecyDomainAllocation” information element (IE) that indicates a frequency domain resource allocation;
(2)“firstOFDMSymbollnTimeDomain” IE that indicates a time domain allocation of a first orthogonal frequency-division multiplexing (OFDM) symbol in a physical resource block (PRB) used for CSI-RS; (3)“nrofSlots” IE that indicates a number of consecutive slots containing the TRS;
(4)“startingRB” IE that indicates a PRB where this CSI resource starts in relation to common resource block #0 (CRB#0) on the common resource block grid; (5)“nrofRBs” IE that indicates a number of PRBs across which this CSI resource spans; (6)“powerContro10ffset” IE that indicates a power offset of Physical Downlink Shared Channel (PDSCH) Resource Element (RE) to NZP CSI-RS RE;
(7)“powerContro10ffsetSS” IE that indicates a power offset of NZP CSI-RS RE to secondary synchronization signal (SSS) RE; (8)“scramblingID1”˜“scramblingID4” IEs that indicate a plurality of scrambling IDs used for scrambling channels and reference signals; and (9)“periodicityAndOffset” IE that indicates a periodicity and a corresponding slot offset. In one example, the scrambling IDs are configured with consecutive numbers (e.g., configured with consecutive numbers, such as scramblingID1=42, scramblingID2=43, scramblingID3=44, scramblingID4=45). In another example, only the first or last scrambling ID is configured with a number (e.g., 42 or 45), and the UE may apply consecutive numbers to the rest scrambling IDs (e.g., 43˜45 or 42˜44). FIG. 5 illustrates an exemplary structure of the TRS configuration in accordance with one novel aspect of the present invention.

To further clarify, the “frequecyDomainAllocation” ID is 4 bits long, the “firstOFDMSymbollnTimeDomain” IE is 4 bits long, the “nrofSlots” IE is 1 bit long, the “startingRB” IE is 9 bits long, the “nrofRBs” IE is 8 bits long, the “powerContro10ffset” IE is 5 bits long, the “powerContro10ffsetSS” IE is 2 bits long, each of the “scramblingID1”˜“scramblingID4” IEs is 10 bits long, and the “periodicityAndOffset” IE is 14 bits long. That is, the total size of the TRS configuration is 87 bits, which is way smaller than the upper bound (i.e., 2976 bits) for a SIB.

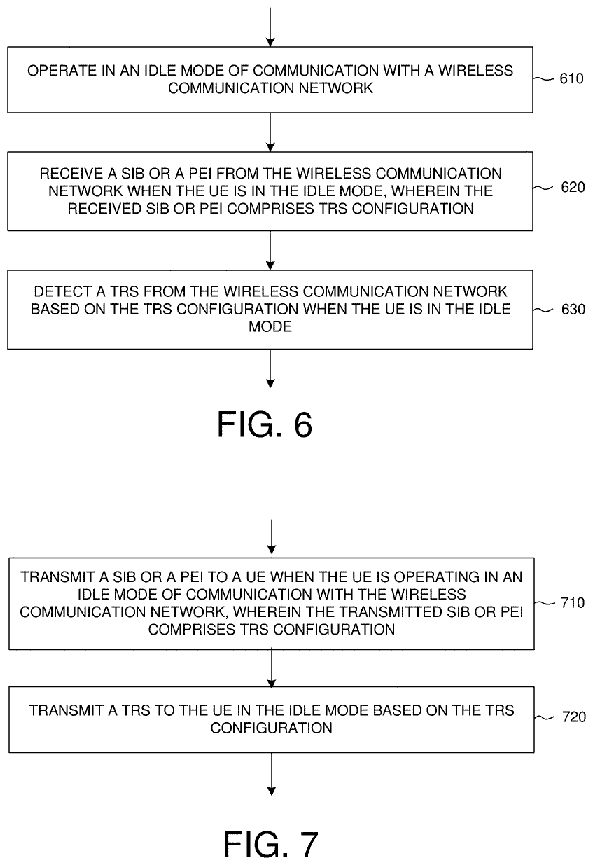

FIG. 6 is a flow chart of a method of providing TRS in idle mode for power consumption enhancements from UE perspective in accordance with one novel aspect of the present invention. In step 610, a UE operates in an idle mode (e.g., RRC_IDLE mode) of communication with a wireless communication network (e.g., 5G NR network). In step 620, the UE receives a SIB or a PEI from the wireless communication network when the UE is in the idle mode, wherein the received SIB or PEI comprises TRS configuration. In step 630, the UE detects a TRS from the wireless communication network based on the TRS configuration when the UE is in the idle mode.

FIG. 7 is a flow chart of a method of providing TRS in idle mode for power consumption enhancements from network perspective in accordance with one novel aspect of the present invention. In step 710, a wireless communication network transmits a SIB or a PEI to a UE when the UE is operating in an idle mode of communication with the wireless communication network, wherein the transmitted SIB or PEI comprises TRS configuration. In step 720, the wireless communication network transmits a TRS to the UE in the idle mode based on the TRS configuration.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
operating in an idle mode of communication with a wireless communication network by a user equipment (UE);
receiving a system information block (SIB) or a paging early indication (PEI) from the wireless communication network when the UE is in the idle mode, wherein the received SIB or PEI comprises tracking reference signal (TRS) configuration; and
detecting a TRS from the wireless communication network based on the TRS configuration when the UE is in the idle mode.

2. The method of claim 1, further comprising:
performing time or frequency tracking in the idle mode based on the detected TRS; and
based on the performed time or frequency tracking, entering a sleep mode for a period of time spanning one or more occasions configured for Synchronization Signal Block (SSB) reception.

3. The method of claim 2, wherein the entering of the sleep mode is performed by skipping the one or more occasions configured for SSB reception.

4. The method of claim 1, wherein the SIB is in an existing type of SIB in a third generation partnership project (3GPP) specification for 5G new radio (NR), or in a new type of SIB additionally introduced to the 3GPP specification for 5G NR.

5. The method of claim 4, wherein the existing type of SIB is a type-2 SIB, or the new type of SIB is a type-15 SIB.

6. The method of claim 1, wherein the TRS configuration comprises information of a periodic non-zero-power (NZP) channel state information-reference signal (CSI-RS) resource set, and TRS information (trs-info) of that the NZP CSI-RS resource set is configured for TRS.

7. The method of claim 6, wherein the information of the NZP CSI-RS resource set comprises at least one of the following:
an information element (IE) indicating a frequency domain resource allocation;
an IE indicating a time domain allocation of a first orthogonal frequency-division multiplexing (OFDM) symbol in a physical resource block (PRB) used for CSI-RS;
an IE indicating a number of consecutive slots containing the TRS;
an IE indicating a PRB where this CSI resource starts in relation to common resource block #0 (CRB#0) on the common resource block grid;
an IE indicating a number of PRBs across which this CSI resource spans;
an IE indicating a power offset of Physical Downlink Shared Channel (PDSCH) Resource Element (RE) to NZP CSI-RS RE;
an IE indicating a power offset of NZP CSI-RS RE to secondary synchronization signal (SSS) RE;
one or more IEs indicating one or more scrambling IDs; and
an IE indicating a periodicity and a corresponding slot offset.

8. The method of claim 7, wherein the scrambling IDs are configured with consecutive numbers, or only the first or last scrambling ID is configured with a number.

9. A user equipment (UE), comprising:
a state configurator circuit that configures the UE to operate in an idle mode of communication with a wireless communication network;
a receiver circuit that receives a system information block (SIB) or a paging early indication (PEI) from the wireless communication network when the UE is in the idle mode, wherein the received SIB or PEI comprises tracking reference signal (TRS) configuration; and
a TRS detection circuit that detects a TRS from the wireless communication network based on the TRS configuration when the UE is in the idle mode.

10. The UE of claim 9, wherein the UE performs time or frequency tracking in the idle mode based on the detected TRS, and based on the performed time or frequency tracking, enters a sleep mode for a period of time spanning one or more occasions configured for Synchronization Signal Block (SSB) reception.

11. The UE of claim 10, wherein the entering of the sleep mode is performed by skipping the one or more occasions configured for SSB reception.

12. The UE of claim 9, wherein the SIB is in an existing type of SIB in a third generation partnership project (3GPP) specification for 5G new radio (NR), or in a new type of SIB additionally introduced to the 3GPP specification for 5G NR.

13. The UE of claim 12, wherein the existing type of SIB is a type-2 SIB, or the new type of SIB is a type-15 SIB.

14. The UE of claim 9, wherein the TRS configuration comprises information of a periodic non-zero-power (NZP) channel state information-reference signal (CSI-RS) resource set, and TRS information (trs-info) of that the NZP CSI-RS resource set is configured for TRS.

15. The UE of claim 14, wherein the information of the NZP CSI-RS resource set comprises at least one of the following:
an information element (IE) indicating a frequency domain resource allocation;
an IE indicating a time domain allocation of a first orthogonal frequency-division multiplexing (OFDM) symbol in a physical resource block (PRB) used for CSI-RS;
an IE indicating a number of consecutive slots containing the TRS;
an IE indicating a PRB where this CSI resource starts in relation to common resource block #0 (CRB#0) on the common resource block grid;
an IE indicating a number of PRBs across which this CSI resource spans;
an IE indicating a power offset of Physical Downlink Shared Channel (PDSCH) Resource Element (RE) to NZP CSI-RS RE;
an IE indicating a power offset of NZP CSI-RS RE to secondary synchronization signal (SSS) RE;
one or more IEs indicating one or more scrambling IDs; and
an IE indicating a periodicity and a corresponding slot offset.

16. The UE of claim 15, wherein the scrambling IDs are configured with consecutive numbers, or only the first or last scrambling ID is configured with a number.

17. A method, comprising:
transmitting a system information block (SIB) or a paging early indication (PEI) to a user equipment (UE) by a wireless communication network when the UE is operating in an idle mode of communication with the wireless communication network, wherein the transmitted SIB or PEI comprises tracking reference signal (TRS) configuration; and
transmitting a TRS to the UE in the idle mode based on the TRS configuration by the wireless communication network.

18. The method of claim 17, wherein the SIB is in an existing type of SIB in a third generation partnership project (3GPP) specification for 5G new radio (NR), or in a new type of SIB additionally introduced to the 3GPP specification for 5G NR; and wherein the existing type of SIB is a type-2 SIB, or the new type of SIB is a type-15 SIB.

19. The method of claim 17, wherein the TRS configuration comprises information of a periodic non-zero-power (NZP) channel state information-reference signal (CSI-RS) resource set, and TRS information (trs-info) of that the NZP CSI-RS resource set is configured for TRS.

20. The method of claim 19, wherein the information on each of the NZP CSI-RS resource sets comprises at least one of the following:
an information element (IE) indicating a frequency domain resource allocation;
an IE indicating a time domain allocation of a first orthogonal frequency-division multiplexing (OFDM) symbol in a physical resource block (PRB) used for CSI-RS;
an IE indicating a number of consecutive slots containing the TRS;
an IE indicating a PRB where this CSI resource starts in relation to common resource block #0 (CRB#0) on the common resource block grid;
an IE indicating a number of PRBs across which this CSI resource spans;
an IE indicating a power offset of Physical Downlink Shared Channel (PDSCH) Resource Element (RE) to NZP CSI-RS RE;
an IE indicating a power offset of NZP CSI-RS RE to secondary synchronization signal (SSS) RE;
one or more IEs indicating one or more scrambling IDs, wherein the scrambling IDs are configured with consecutive numbers, or only the first or last scrambling ID is configured with a number; and
an IE indicating a periodicity and a corresponding slot offset.
